(19) United States
(12) Patent Application Publication
(10) Pub. No.: US 2008/0123023 A1
(43) Pub. Date: May 29, 2008

(54) WHITE LIGHT UNIT, BACKLIGHT UNIT AND LIQUID CRYSTAL DISPLAY DEVICE USING THE SAME

(76) Inventors: TRUNG DOAN, Los Gatos, CA (US); Wen-Huang Liu, Guan-Xi Town (TW); Jui-Kang Yen, Taipei City (TW); Yung-Wei Chen, Taichung City (TW); Ching-Tai Cheng, Hsinchu City (TW)

Correspondence Address: PATTERSON & SHERIDAN, L.L.P., 3040 POST OAK BOULEVARD, SUITE 1500, HOUSTON, TX, 77056, US

(21) Appl. No.: 11/468,363

(22) Filed: Aug. 30, 2006

(51) Int. Cl. G02F 1/1335; F21V 9/16

(52) U.S. Cl. 349/70; 362/84

(57) ABSTRACT

A white light source using solid state technology, as well as general backlight units and liquid crystal displays (LCDs) that may incorporate such a white light source, are provided. The white light source described herein utilizes a monochrome light-emitting diode (LED) and a wavelength-converting layer having fluorescent materials to produce a substantially uniform broadband optical spectrum visible as white light. Being constructed on a metal substrate, the white light source may also provide for an improved heat transfer path over conventional solid state white light sources.

### BACKGROUND OF THE INVENTION

1. Field of the Invention

Embodiments of the present invention generally relate to light sources, and, more particularly, to solid state sources of white light that may be employed in backlights, such as those used in liquid crystal displays (LCDs).

2. Description of the Related Art

Light emitting diodes (LEDs) have several benefits to offer in many lighting applications including their small size, low power requirements, reliability, and long life when compared to traditional light sources, such as incandescent light bulbs. However, creating an acceptable white light source using LEDs has proven to be a technological challenge.

For example, some so-called “white” LEDs in production today make use of a blue GaN LED covered by a yellowish phosphor coating typically made of cerium-doped yttrium aluminum garnet (YAG:Ce³⁺) crystals that have been powdered and bound in a type of viscous adhesive. The blue LED die emits blue light at a wavelength of about 450 to 470 nm, a portion of which is converted to a broad spectrum centered at about 580 nm, or yellow light. Since yellow light stimulates the red and green receptors of the eye, the resulting mix of blue and yellow light gives the appearance of white. However, the bluish-yellow “lunar white” color produced may not be acceptable in some applications. With the resulting optical spectrum lacking red light, the color of LCDs employing such lunar white LEDs may not be sufficiently saturated. Furthermore, these LEDs may have a noticeable color ring where the color towards the edges is different than in the center.

One of the applications for solid state lighting from LEDs includes backlights, which are often employed in illuminating the LCDs of computer monitors, televisions, mobile phones, and personal digital assistants (PDAs). As illustrated in FIG. 1, a conventional backlight 100 utilizing solid state technology typically uses individual red (R), green (G), and blue (B) LEDs 110 arranged in a repeating pattern 120, such as GBRG. Individual red, green, and blue light emitted from the LEDs arranged in such a pattern combine to give the appearance of visible white light. However, emitting different colors of light from various LEDs requires different chemical elements. For instance, red light may be produced by GaAsP LEDs, while blue light may be generated from InGaN LEDs. These different chemical compositions may degrade at different rates, and therefore, the uniformity of the optical spectrum visible as white light may not be maintained over time when separate red, green, and blue LEDs are used.

Accordingly, what is needed is an improved solid state white light source that may be incorporated into general backlights and the backlights of LCDs.

### SUMMARY OF THE INVENTION

One embodiment of the invention provides for a backlight unit having at least one solid state device configured to emit substantially white light. The solid state device generally includes at least one light-emitting diode (LED) semiconductor die having an epitaxial structure on a metal substrate configured to emit a first light with a peak wavelength shorter than 415 nm and a wavelength-converting layer configured to at least partially absorb the first light and emit a broadband optical spectrum, wherein the wavelength-converting layer comprises fluorescent materials and a filler material.

Another embodiment of the present invention provides for a liquid crystal display (LCD) device. The LCD device generally includes an LCD panel and a backlight unit for illuminating the LCD panel comprising one or more solid state white light sources, wherein each white light source comprises at least one light-emitting diode (LED) semiconductor die having an epitaxial structure on a metal substrate configured to emit a first light with a peak wavelength shorter than 415 nm and a wavelength-converting layer configured to at least partially absorb the first light and emit a broadband optical spectrum, wherein the wavelength-converting layer comprises fluorescent materials and a filler material.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a prior art light-emitting diode (LED) backlight using individual red, green, and blue LEDs;

FIG. 2A is a cross-sectional schematic representation of a white light source in accordance with an embodiment of the invention;

FIG. 2B is an exploded cross-sectional schematic representation of the LED semiconductor die in FIG. 2A in accordance with an embodiment of the invention;

FIG. 3 is an exemplary optical spectrum of a white light source in accordance with an embodiment of the invention;

FIG. 4 is a cross-sectional schematic representation of a white light source depicting multiple LED semiconductor dies in accordance with an embodiment of the invention;

FIG. 5 is a diagram of the components of an exemplary backlight for emitting white light in accordance with an embodiment of the invention;

FIG. 6 is a diagram of the components of another exemplary backlight for emitting white light in accordance with an embodiment of the invention;

FIG. 7 is a diagram of the components of an LCD using the backlight of FIG. 5 in accordance with an embodiment of the invention; and

FIG. 8 is a diagram of the components of an LCD using the backlight of FIG. 6 in accordance with an embodiment of the invention.

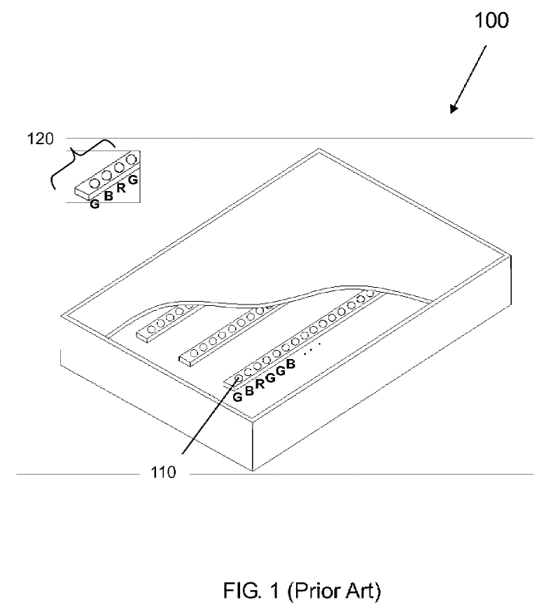

### DETAILED DESCRIPTION

Embodiments of the present invention provide a white light source using solid state technology, as well as general backlight units and liquid crystal displays (LCDs) that may incorporate such a white light source. The white light source described herein utilizes a monochrome light-emitting diode (LED) and a wavelength-converting layer having a fluorescent material to produce a substantially uniform, broadband optical spectrum visible as white light. The broadband optical spectrum may comprise red, green, and blue spectra. Being constructed on a metal substrate, the white light source may also provide for an improved heat transfer path over conventional solid state white light sources.

### An Exemplary White Light Source

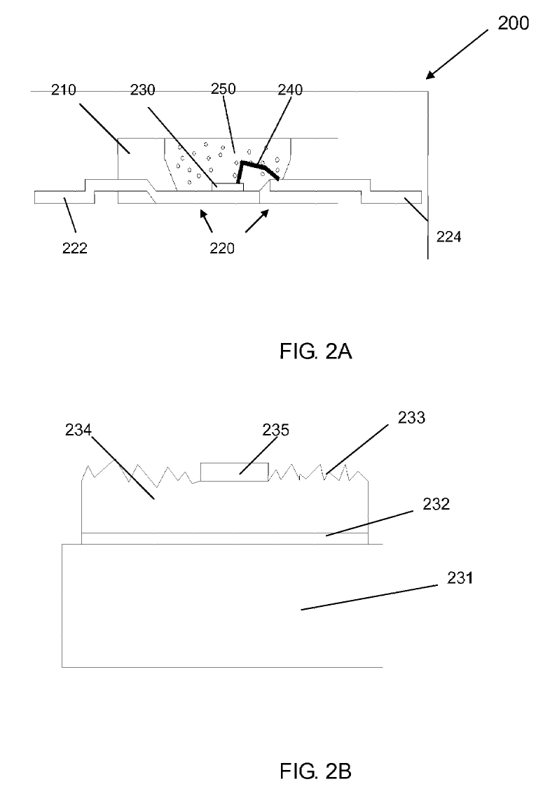

FIG. 2A is a cross-sectional schematic representation of a solid state white light source 200 in accordance with one embodiment of the invention. The white light source 200 may comprise an LED semiconductor die 230 designed to emit light, for example, having an optical spectrum with a peak wavelength of less than 415 nm. This wavelength range corresponds to violet and ultraviolet (UV) light in the electromagnetic spectrum. To generate these shorter light wavelengths, the LED die 230 may comprise one of several semiconductor materials, such as GaN, AlN, AlGaN, InGaN, or InAlGaN.

To produce white light, at least a portion of the LED die 230 may be covered by a wavelength-converting layer 250. The wavelength-converting layer 250 may be composed of materials that absorb the violet or UV light from the LED die 230 and emit white light, or at least a substantially uniform optical spectrum akin to pure white light. To convert violet or UV light to white light, the wavelength-converting layer 250 may comprise fluorescent materials that absorb the incident violet or UV radiation and emit a broadband optical spectrum comprising red, blue, and green spectra. Those skilled in the art will recognize that phosphorescent material may also be used in place of fluorescent material, although fluorescent material will be described henceforth. The fluorescent materials may be suspended or bound in a filler material, such as a glue or resin (e.g., epoxy, silicone, and acrylic resin), after mixing the fluorescent and filler materials together. The filler material may be transparent or, for some embodiments, translucent.

To emit red, green, and blue spectra, the fluorescent materials may be composed of red fluorescent material, green fluorescent material, and blue fluorescent material. The red fluorescent materials may include, for example, Y₂O₂S:Eu, MₓSi_{y}N_{z}:Eu (where M=Ca, Sr, or Ba), or [0.5MgF₂-3.5MgO—GeO₂]:Mn. The green fluorescent materials may consist of, for example, MSi₂O₂₋ₓN_{2+2/3x}:Eu (where M=Ba, Ca, or Sr), ZnS:(Cu⁺, Al³⁺), Sr₂SiO₄:Eu, SrAl₂O₄:Eu, or SrGa₂S₄:Eu. The blue fluorescent materials may comprise, for example, BaMgAl₁₀O₁₇:Eu.

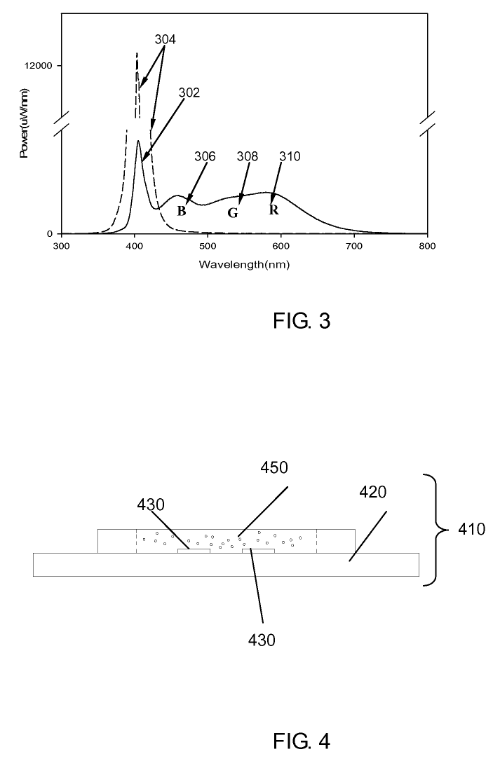

In the wavelength-converting layer 250, the light produced from the fluorescent materials may produce a substantially uniform optical spectrum 302 visible as white light as illustrated in FIG. 3. The intensity of a UV LED semiconductor die may be observed in the UV spectrum 304 having an intensity of about 12000 μW/nm for some embodiments. The combined spectrum 302 may be decomposed into individual contributions from a blue light spectrum 306, a green light spectrum 308, and a red light spectrum 310, in addition to a remnant of the UV spectrum 304. The violet or UV light produced by the LED semiconductor die 230 may lose intensity as it is transmitted through and absorbed by various components of the wavelength-converting layer 250.

Referring to FIG. 2B, the details of the LED semiconductor die 230 in the exemplary white light source of FIG. 2A are depicted. To create electrical properties characteristic of a diode, one portion of the LED die 230 may be intentionally doped with impurities to create a p-doped region 232, while an n-doped region 234 is created on another side of the LED die 230. A multiple quantum well (MQW) active layer (not shown), which actually produces the light having a peak wavelength less than 415 nm, may be interposed between the p-doped region 232 and the n-doped region 234. The p-doped region 232 may be adjacent to a metal substrate 231 for efficient heat transfer away from the LED semiconductor die 230, and the metal substrate 231 may be coupled to a lead frame 220 for external connection. Composed of a single metal or a metal alloy of suitable conductive material (e.g., copper, nickel, and aluminum), the metal substrate 231 may comprise a single or multiple layers, wherein the multiple layers may be of similar or different compositions.

There may also be a reflective layer (not shown) interposed between the p-doped region 232 and the metal substrate. The reflective layer may reflect light produced in the active layer and direct it into the wavelength-converting layer 250 and in the general direction of light emission for the white light source 200. Increasing the light efficiency of the white light source 200, the reflective layer may be composed of any suitable material capable of reflecting light, such as Ag, Al, Ni, Pd, Au, Pt, Ti, Cr, Vd, and combinations thereof.

For some embodiments of the white light source 200, a surface 233 of the n-doped region 234 may be roughened in an effort to increase the surface area and, thus, the light extraction from the LED semiconductor die 230. The roughened surface 233 may be accomplished by any suitable technique, such as wet etching, dry etching, or photolithography. The n-doped region 234 may also have a bond pad 235 coupled to it for connection to the lead frame 220, which provides external connection.

For some embodiments, the LED semiconductor die 230 may be attached to a first lead 222 by metal solder or some other type of suitable heat-conducting material. The first lead 222 may be intimately connected with the metal substrate 231 for efficient heat transfer immediately away from the LED die 230 as disclosed in commonly owned U.S. patent application Ser. No. 11/279,523, filed Apr. 12, 2006, herein incorporated by reference. A second lead 224 may be electrically connected to the LED die 230 through a bond wire 240, made of a conductive material, such as gold, which may be connected with the bond pad 235. For some embodiments, the first lead 222 may be made larger than necessary for electrical conduction (within the dimensions of the white light source package) in an effort to allow for greater heat transfer and, in such cases, will typically be larger than the second lead 224.

In any case, the lead frame 220 (consisting of both leads 222, 224, and the bond wire 240) may be positioned at the bottom of the white light source 200, which may result in lower thermal resistance and better heat-sinking capability than the prior art. In the illustrated example of FIG. 2A, the LED die 230 is encased in a cylindrical housing 210 composed of an insulating material, such as plastic. Inner surfaces of the housing 210 may have a slope to them. At least a portion of the recessed volume inside the housing 210 may be filled with the filler material constituting the wavelength-converting layer 250.

As illustrated, a first surface of each of the leads 222, 224 may be enclosed in the housing 210, while a second surface of each of the leads 222, 224 may be substantially exposed through (a bottom portion of) the housing 210. For example, 10-50% or more of the second surface of one or both of the leads 222, 224 may be exposed. This substantial exposure of the lead(s) to the external world (e.g., for connection to a PCB, a heat sink, or other type of mounting surface) may greatly enhance thermal conductivity.

Referring to FIG. 4, some embodiments of a white light source 410 may comprise a plurality of LED semiconductor dies 430 emitting light having a peak wavelength less than 415 nm and disposed on a metal substrate 420. Multiple LED semiconductor dies 430 within a single white light source 410 may be utilized to increase the light emission over that produced by a single LED semiconductor die or to distribute the produced white light within a single device. The multiple LED semiconductor dies 430 may be covered by a wavelength-converting layer 450 for absorbing the emitted light and converting it to white light. The wavelength-converting layer 450 may comprise fluorescent materials and a filler material as described above.

### An Exemplary Backlight Structure

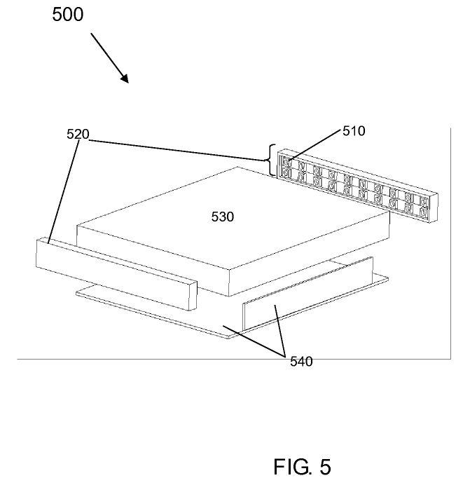

The white light sources described herein may be incorporated into a backlight structure to provide white illumination. FIG. 5 is a diagram of the components of an exemplary backlight structure 500 for emitting white light using white light sources according to embodiments of the invention. The backlight structure 500 may comprise one or more light units 520 disposed adjacent to a light guide 530. For the example, two light units 520 are shown disposed on opposite lateral surfaces of the light guide. The backlight 500 may include a reflector 540 for reflecting light produced in the light units 520 in an effort to direct the light in one general emitting direction (out of the top surface of the light guide 530 in the example of FIG. 5). The light units 520 may be composed of one or more white light sources 510 as described above, wherein each white light source 510 may comprise a single LED semiconductor die or a plurality of LED dies. Furthermore, the light units 520 may comprise a printed circuit board (PCB) for mounting, connecting, and powering the one or more white light sources 510.

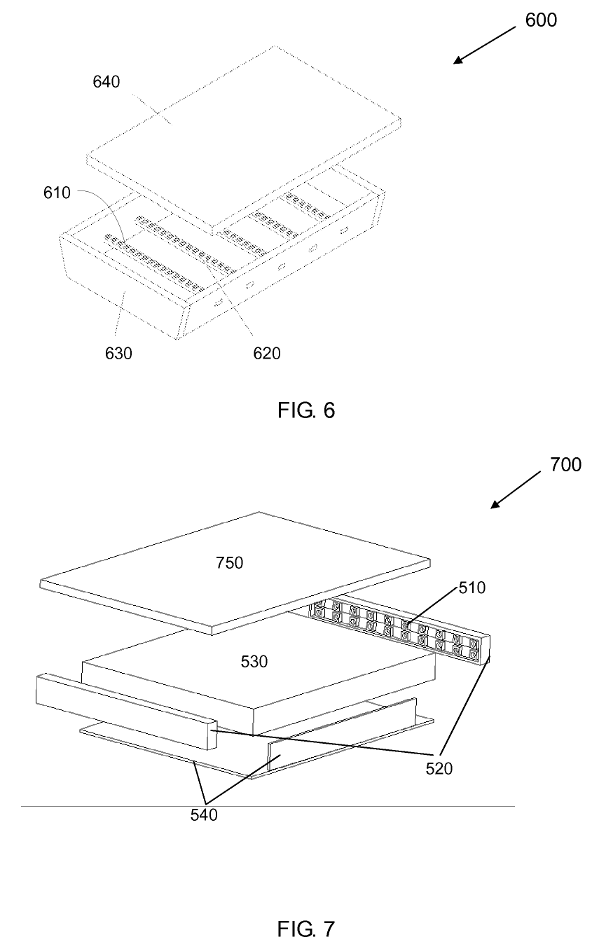

FIG. 6 is a diagram illustrating another example of a backlight structure 600 for emitting white light using white light sources according to embodiments of the invention. The backlight structure 600 may comprise a back cover 630 containing one or more white light sources 610 as described herein. For some embodiments, the white light sources 610 may be arranged in rows to form a light unit 620, and these light units 620 may be uniformly spaced within the back cover 630. In other embodiments, the white light sources 610 may be coupled to a suitable mounting structure, such as a PCB or a heat sink, housed within the back cover 630. The back cover 630 may be opaque, and for some embodiments, at least some of the interior surfaces of the back cover 630 may be covered with a reflective material (e.g., aluminum foil) to increase the light extraction from the backlight 600. The walls—or at least the interior surface of the walls—of the back cover 630 may be sloped for some embodiments.

Since the white light produced from the plurality of white light sources 610 within the backlight structure 600 may be unevenly distributed, the backlight structure 600 may employ a diffuser 640 disposed above the back cover 630 in an effort to provide even lighting. The diffuser 640 may be a specially designed layer of plastic that diffuses the light through a series of evenly-spaced bumps. These bumps may have a density distribution, whereby the density of bumps increases in certain locations relative to the light sources 610 according to a defined mathematical formula.

Unlike conventional backlights with separate red, green, and blue LEDs, the white light in backlights according to embodiments of the invention may be produced by single units: the white light sources. In other words, a single LED semiconductor die combined with the wavelength-converting layer as described herein is capable of producing white light with a fairly uniform optical spectrum. As such a white light source degrades, the total intensity may decrease, but the uniformity of the white light may remain, an advantage over conventional solid state backlights.

### An Exemplary LCD Device

Backlights are commonly used to illuminate transmissive liquid crystal displays (LCDs) from the side or the back. Transmissive LCDs are viewed from the opposite side (the front) and may be employed in applications requiring high luminance levels, such as computer monitors, televisions, personal digital assistants (PDAs), and cellular telephones. As such, backlight structures utilizing white light sources described herein may be applied to LCD devices.

FIG. 7 is a diagram of the components of an exemplary LCD 700 using the backlight structure of FIG. 5 in accordance with one embodiment of the invention. White light emitted from the one or more white light sources 510 in the light units 520 may enter the light guide 530 from the sides and may be directed towards an LCD panel 750. Disposed above the light guide 530, the LCD panel 750 may consist of a liquid crystal that is sandwiched between layers of glass or plastic and a polarizing filter and may become opaque when electric current passes through it. The reflector 540 may redirect what otherwise would be wasted light towards the LCD panel 750.

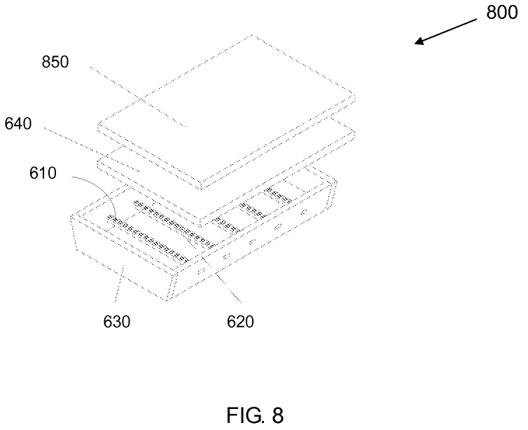

FIG. 8 is a diagram of the components of another exemplary LCD 800 using the backlight structure of FIG. 6 in accordance with one embodiment of the invention. White light emitted from the one or more white light sources 610 in the light units 620 may be directed towards the diffuser 640 in an effort to produce an even light source. The even white light may be emitted into an LCD panel 850 disposed above the diffuser 640, and the LCD panel 850 may comprise similar materials and function in a similar manner as described above.

While the foregoing is directed to embodiments of the present invention, other and further embodiments of the invention may be devised without departing from the basic scope thereof, and the scope thereof is determined by the claims that follow:

1. A backlight unit comprising at least one solid state device configured to emit substantially white light, the solid state device comprising:
at least one light-emitting diode (LED) semiconductor die having an epitaxial structure on a metal substrate configured to emit a first light with a peak wavelength shorter than 415 nm; and
a wavelength-converting layer configured to at least partially absorb the first light and emit a broadband optical spectrum, wherein the wavelength-converting layer comprises fluorescent materials and a filler material.

2. The backlight unit of claim 1, wherein the epitaxial structure comprises:
a p-doped region disposed above the metal substrate;
an active layer disposed above the p-doped region; and
an n-doped region disposed above the active layer.

3. The backlight unit of claim 2, wherein the p-doped region, the active layer, or the n-doped region comprises at least one of GaN, AlN, AlGaN, InGaN, and InAlGaN.

4. The backlight unit of claim 1, wherein the filler material is at least one of a resin and a glue.

5. The backlight unit of claim 1, wherein the filler material is transparent.

6. The backlight unit of claim 1, wherein the fluorescent materials comprise a red fluorescent material, a green fluorescent material, and a blue fluorescent material.

7. The backlight unit of claim 6, wherein the red fluorescent material comprises at least one of [0.5MgF₂-3.5MgO—GeO₂]:Mn, Y₂O₂S:Eu, and MₓSi_{y}N_{z}:Eu (where M=Ca, Sr, or Ba).

8. The backlight unit of claim 6, wherein the green fluorescent material comprises at least one of MSi₂O₂₋ₓN_{2+2/3x}:Eu (where M=Ba, Ca, or Sr), ZnS:(Cu⁺, Al³⁺), Sr₂SiO₄:Eu, SrAl₂O₄:Eu, and SrGa₂S₄:Eu.

9. The backlight unit of claim 6, wherein the blue fluorescent material comprises BaMgAl₁₀O₁₇:Eu.

10. The backlight unit of claim 1, wherein the filler material and the fluorescent materials are mixed and bound together.

11. The backlight unit of claim 1, wherein the broadband optical spectrum comprises a substantially blue spectrum, a substantially green spectrum, and a substantially red spectrum.

12. The backlight unit of claim 1, further comprising a housing having a recessed volume, wherein the LED semiconductor die is disposed within the recessed volume of the housing and at least a portion of the recessed volume above the LED semiconductor die contains the wavelength-converting layer.

13. The backlight unit of claim 12, further comprising a lead frame having a first lead and a second lead for external connection, wherein the first and second leads are exposed through a bottom portion of the housing, the first lead is thermally and electrically coupled to a first polarity of the LED semiconductor die, and the second lead is electrically coupled to a second polarity of the LED semiconductor die.

14. The backlight unit of claim 1, wherein the metal substrate comprises multiple layers.

15. The backlight unit of claim 1, wherein the metal substrate comprises a metal or a metal alloy and comprises at least one of copper, nickel, and aluminum.

16. The backlight unit of claim 1, further comprising a light guide adapted to guide the substantially white light emitted from the at least one solid state device.

17. The backlight unit of claim 1, further comprising a reflector configured to redirect the substantially white light emitted from the at least one solid state device in a general light emitting direction for the backlight unit.

18. The backlight unit of claim 1, further comprising a diffuser configured to accept the substantially white light emitted from the at least one solid state device and emit substantially even white light.

19. The backlight unit of claim 1, wherein the at least one solid state device is coupled to a printed circuit board (PCB) or a heat sink.

20. A liquid crystal display (LCD) device comprising:
an LCD panel; and
a backlight unit for illuminating the LCD panel comprising one or more solid state white light sources, wherein each white light source comprises at least one light-emitting diode (LED) semiconductor die having an epitaxial structure on a metal substrate configured to emit a first light with a peak wavelength shorter than 415 nm and a wavelength-converting layer configured to at least partially absorb the first light and emit a broadband optical spectrum, wherein the wavelength-converting layer comprises fluorescent materials and a filler material.
